(19) United States
(12) Patent Application Publication
(10) Pub. No.: US 2025/0105480 A1
(43) Pub. Date: Mar. 27, 2025

(54) METHOD FOR MANUFACTURING BATTERY

(71) Applicant: TOYOTA JIDOSHA KABUSHIKI KAISHA, Toyota-shi (JP)

(72) Inventors: Mitsuru TATEISHI, Toyota-shi (JP); Hajime Hasegawa, Aichi-gun (JP); Tomoyuki Kawai, Kariya-shi (JP); Kisena Yoshida, Kariya-shi (JP)

(73) Assignee: TOYOTA JIDOSHA KABUSHIKI KAISHA, Toyota-shi (JP)

(21) Appl. No.: 18/789,921

(22) Filed: Jul. 31, 2024

(30) Foreign Application Priority Data
Sep. 21, 2023 (JP) 2023-156443

(51) Int. Cl. H01M 50/609; H01M 10/0568; H01M 10/44

(52) U.S. Cl. CPC H01M 50/609; H01M 10/0568; H01M 10/446; H01M 2300/0025

(57) ABSTRACT

A method for manufacturing a battery, including: a first injection step of injecting a first electrolytic solution that contains lithium bis(fluorosulfonyl)imide into an electrode body having a positive electrode, a negative electrode, and a separator interposed between the positive electrode and the negative electrode; a first charging step of performing first charging after the first injection step; a first aging step of performing aging treatment after the first charging step; a second injection step of injecting a second electrolytic solution that does not contain lithium bis(fluorosulfonyl)imide into the electrode body after the first aging step; a second charging step of performing second charging after the second injection step; and a second aging step of performing aging treatment after the second charging step.

### CROSS-REFERENCE TO RELATED APPLICATION

This application claims priority to Japanese Patent Application No. 2023-156443 filed on Sep. 21, 2023, incorporated herein by reference in its entirety.

### BACKGROUND

### 1. Technical Field

The present disclosure relates to a method for manufacturing a battery.

### 2. Description of Related Art

Combined usage of two or more types of electrolytic solutions is being considered in a battery of the related art. When this battery is manufactured, a first type of electrolytic solution is injected into the electrode body and charging and aging treatment are performed. Then, a second type of electrolytic solution is injected into the electrode body and charging and aging treatment are performed, for example.

For example, Japanese Unexamined Patent Application Publication No. 2022-141405 discloses a method for manufacturing a non-aqueous electrolyte secondary battery. The method includes a step of preparing an assembly including a positive electrode, a negative electrode, and a first electrolytic solution that does not substantially contain lithium bis(fluorosulfonyl)imide and contains a negative-electrode film forming agent, a step of forming a film on the negative electrode in the assembly by the negative-electrode film forming agent, and a step of injecting a second electrolytic solution that contains lithium bis(fluorosulfonyl)imide into the assembly.

Japanese Unexamined Patent Application Publication (Translation of PCT application) No. 2022-553168 discloses a secondary battery. The secondary battery has a negative electrode sheet and an electrolytic solution, the negative electrode sheet includes a negative-electrode current collector, and a negative electrode film that is disposed on at least one surface of the negative-electrode current collector and that contains a negative-electrode active material, and the electrolytic solution has an electrolyte salt and an organic solvent. Here, the negative-electrode active material includes a silicon-based material, the organic solvent includes ethylene carbonate (EC) and ethyl methyl carbonate (EMC), the weight occupancy rate of the ethylene carbonate (EC) in the organic solvent is ≤10%, and the weight occupancy rate of the ethyl methyl carbonate (EMC) in the organic solvent is from 70% to 95%.

Japanese Unexamined Patent Application Publication (Translation of PCT application) No. 2022-551946 discloses a secondary battery. In the secondary battery, an electrolytic solution having electrolyte salt and an organic solvent is included, the electrolyte salt includes lithium bis(fluorosulfonyl)imide (LiFSI) and lithium hexafluorophosphate (LiPF₆), the molar concentration of lithium bis(fluorosulfonyl)imide (LiFSI) in the electrolytic solution is from 0.8 mol/L to 1.2 mol/L, the molar concentration of lithium hexafluorophosphate (LiPF₆) in the electrolytic solution is from 0.15 mol/L to 0.4 mol/L, the organic solvent includes ethylene carbonate (EC), and the mass occupancy rate of ethylene carbonate (EC) in the organic solvent is ≤20%.

### SUMMARY

In equipment that manufactures a battery, SUS304 is used as stainless steel, and there are cases where SUS304 and SUS430 are used together, for example. There is a risk that “SUS304” or “SUS304 and SUS430” may be mixed into the electrode body. When these foreign matters are mixed into the electrode body, the foreign matters can be dissolved and precipitated by applying aging treatment for a long amount of time.

However, it is not preferred to perform the aging treatment for a long amount of time from the viewpoints of complexity of a manufacturing step and the like. Therefore, a method for manufacturing a battery capable of dissolving and precipitating mixed foreign matters and shortening the amount of time of the aging treatment is desired.

The present disclosure has been made in view of the situation described above, and an object thereof is to provide a method for manufacturing a battery capable of shortening an amount of time of aging treatment in a first aging step and a second aging step.

Means for solving the problem described above includes an aspect as follows.
<1> A method for manufacturing a battery, including:
   a first injection step of injecting a first electrolytic solution that contains lithium bis(fluorosulfonyl)imide into an electrode body having a positive electrode, a negative electrode, and a separator interposed between the positive electrode and the negative electrode;
   a first charging step of performing first charging after the first injection step;
   a first aging step of performing aging treatment after the first charging step;
   a second injection step of injecting a second electrolytic solution that does not contain lithium bis(fluorosulfonyl)imide into the electrode body after the first aging step;
   a second charging step of performing second charging after the second injection step; and
   a second aging step of performing aging treatment after the second charging step.
<2> The method for manufacturing a battery according to <1>, in which the second electrolytic solution may contain lithium hexafluorophosphate.
<3> The method for manufacturing a battery according to <1> or <2>, in which a working potential of a positive-electrode active material included in the positive electrode may be 4 V (vs. Li/Li⁺) or less.

According to the present disclosure, the method for manufacturing a battery capable of shortening the amount of time of the aging treatment in the first aging step and the second aging step is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a scheme of a method for manufacturing a battery according to an embodiment of the present disclosure;

FIG. 2 is a schematic sectional view seen from a side surface for describing an experiment apparatus used in an experiment example; and

FIG. 3 is a schematic sectional view of the experiment apparatus shown in FIG. 2 seen from an upper surface.

### DETAILED DESCRIPTION OF EMBODIMENTS

An embodiment that is one example of the present disclosure is described below. The descriptions and examples are for exemplifying the embodiment and do not limit the scope of the disclosure.

In a numerical range described in stages in the present specification, an upper limit value or a lower limit value described in one numerical range may be replaced with an upper limit value or a lower limit value of another numerical range described in stages. In a numerical range described in the present specification, an upper limit value or a lower limit value of the numerical range may be replaced with a value described in the example.

In the present specification, regarding the wording of a “step”, not only a case of an independent step but also a case where a clear distinction cannot be made from other steps is included in this term as long as the intended purpose of the step is achieved.

Each component may contain a plurality of types of corresponding materials.

The following can be said when the amount of each component in a composition is referred to. When there is a plurality of types of materials corresponding to each component in the composition, the amount means the total amount of the plurality of types of materials in the composition unless otherwise noted.

### Method for Manufacturing Battery

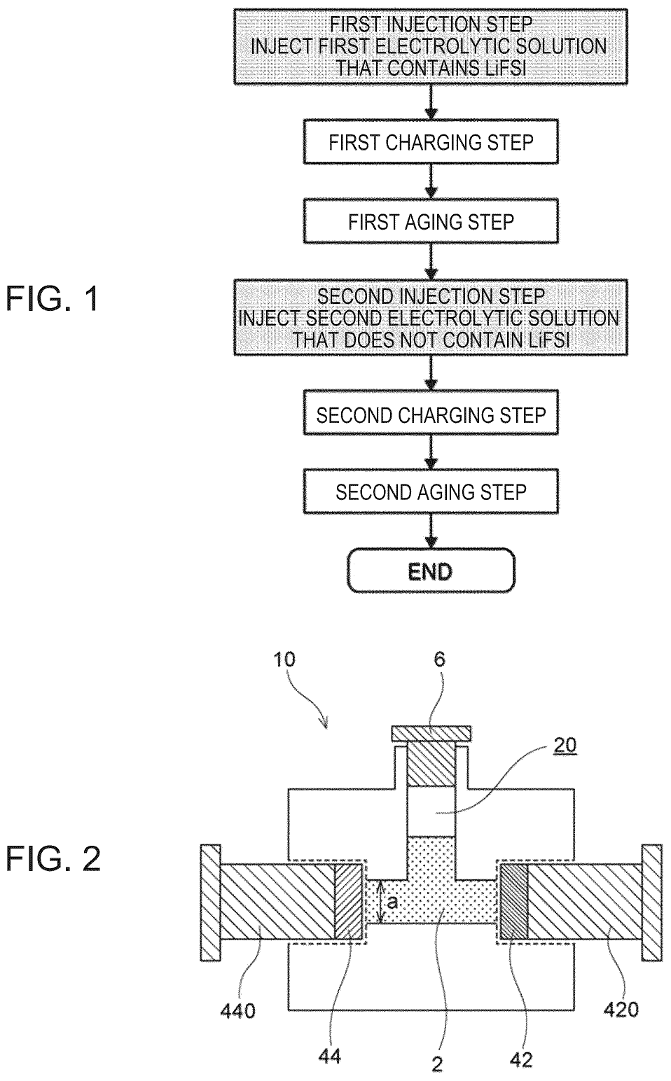

A method for manufacturing a battery according to an embodiment of the present disclosure has each of the following steps as in a scheme shown in FIG. 1.
(First injection step) A step of injecting a first electrolytic solution that contains lithium bis(fluorosulfonyl)imide (LiFSI) into an electrode body having a positive electrode, a negative electrode, and a separator interposed between the positive electrode and the negative electrode
(First charging step) A step of performing first charging after the first injection step
(First aging step) A step of performing an aging treatment after the first charging step
(Second injection step) A step of injecting a second electrolytic solution that does not contain lithium bis(fluorosulfonyl)imide (LiFSI) into the electrode body after the first aging step
(Second charging step) A step of performing second charging after the second injection step
(Second aging step) A step of performing an aging treatment after the second charging step

The method for manufacturing the battery according to the embodiment of the present disclosure can shorten the amount of time of the aging treatment in the first aging step and the second aging step by having each of the steps described above. Reasons thereof are inferred as below.

In a general liquid battery, for example, an electrode body having a positive electrode, a negative electrode, and a separator is prepared, and an electrolytic solution is injected into the electrode body. Then, initial charging is performed, and aging treatment is further performed. As a result, the battery is manufactured. For the purpose of improving various performances of the battery, two or more types of electrolytic solutions are being injected. For example, a battery is manufactured by injecting a first type of electrolytic solution into the electrode body and performing charging and aging treatment and then injecting a second type of electrolytic solution into the electrode body and performing charging and aging treatment.

In equipment that manufactures a battery, more specifically, equipment that manufactures an electrode body having a positive electrode, a negative electrode, and a separator before an electrolytic solution is injected, SUS304 is used as stainless steel, and there are cases where SUS304 and SUS430 are used together, for example. There is a risk that “SUS304” or “SUS304 and SUS430” (hereinafter simply referred to as an SUS foreign matter) may be mixed into the electrode body. When the SUS foreign matter is mixed into the electrode body, the SUS foreign matter can be dissolved and precipitated by applying aging treatment for a long amount of time.

However, it is not preferred to perform the aging treatment for a long amount of time from the viewpoints of complexity of a manufacturing step and cost. Therefore, a method for manufacturing a battery capable of dissolving and precipitating mixed SUS foreign matters and shortening the amount of time of the aging treatment even when there is a risk that the SUS foreign matters may be mixed into the electrode body is desired.

Meanwhile, the method for manufacturing a battery according to the embodiment of the present disclosure injects both of the first electrolytic solution that contains LiFSI and the second electrolytic solution that does not contain LiFSI into the electrode body. In this method for manufacturing a battery, the first electrolytic solution is injected to the electrode body first and the first charging step and the first aging step are applied, and then the second electrolytic solution is injected and the second charging step and the second aging step are applied.

Here, when the first electrolytic solution that contains LiFSI is injected in the first injection step and then the second electrolytic solution that does not contain LiFSI is injected in addition to the first electrolytic solution in the second injection step, the SUS foreign matter is dissolved in the first electrolytic solution in the first aging step, and the SUS foreign matter is dissolved in a mixed electrolytic solution of the first electrolytic solution and the second electrolytic solution in the second aging step. Meanwhile, when the second electrolytic solution that does not contain LiFSI is injected in the first injection step and then the first electrolytic solution that contains LiFSI is injected in addition to the second electrolytic solution in the second injection step, the SUS foreign matter is dissolved in the second electrolytic solution in the first aging step, and the SUS foreign matter is dissolved in the mixed electrolytic solution of the first electrolytic solution and the second electrolytic solution in the second aging step.

As described later, the dissolubility of the SUS foreign matter in the first electrolytic solution that contains LiFSI is extremely high as compared to that in the second electrolytic solution that does not contain LiFSI. Therefore, in the method for manufacturing a battery according to the embodiment of the present disclosure, the amount of time of the aging treatment can be shortened by causing the electrolytic solution to be injected in the first injection step and the second injection step to be in the order described above.

### Experiment Example

Here, the dissolubility of SUS304 and SUS430 by the aging treatment in the first electrolytic solution that contains LiFSI, the second electrolytic solution that does not contain LiFSI, and the mixed electrolytic solution of the first electrolytic solution and the second electrolytic solution is described by showing an experiment example.

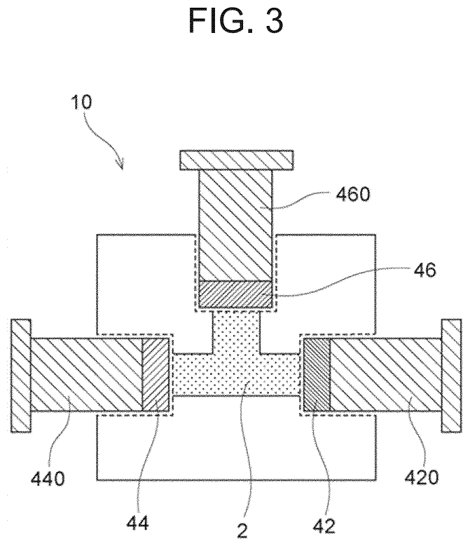

First, an experiment apparatus that was used is described. FIG. 2 is a schematic sectional view showing a configuration of the experiment apparatus using a cyclic voltammetry method seen from a side surface, and FIG. 3 is a schematic sectional view of the experiment apparatus shown in FIG. 2 seen from an upper surface.

As shown in FIG. 2 and FIG. 3, the experiment apparatus 10 includes a working electrode 42 (specifically, an SUS304 foil or an SUS430 foil), a terminal 420 that comes into contact with the working electrode 42 from the reverse side and also serves as a screw lid, a counter electrode 44 (specifically, a Li foil) disposed to face the working electrode 42, a terminal 440 that comes into contact with the counter electrode 44 from the reverse side and also serves as a screw lid, a reference electrode 46 (specifically, a Li foil), and a terminal 460 that comes into contact with the reference electrode 46 from the reverse side and also serves as a screw lid. The working electrode 42, the counter electrode 44, and the reference electrode 46 are connected to each other through a space 20 that is provided on the inner side of the apparatus and is for injecting an electrolytic solution 2, and a screw lid 6 that can be opened and closed is provided in an inlet port of the space 20. A diameter a of each of regions at which the space 20 comes into contact with the working electrode 42, the counter electrode 44, and the reference electrode 46 (in other words, regions at which the electrolytic solution 2 injected into the space 20 comes into contact with the working electrode 42, the counter electrode 44, and the reference electrode 46) is φ10 mm.

An SUS304 foil or an SUS430 foil was provided as the working electrode 42 of the experiment apparatus 10, a Li foil was provided as the counter electrode 44 and the reference electrode 46, and all of the working electrode 42, the counter electrode 44, and the reference electrode 46 were sealed with the terminals 420, 440, and 460 also serving as screw lids. Next, the electrolytic solution was injected from the inlet port of the space 20 such that the regions in contact with the working electrode 42, the counter electrode 44, and the reference electrode 46 were all filled with the electrolytic solution. Then, the inlet port was sealed with the screw lid 6. As the electrolytic solution, three types of liquid as follows were used.
A first electrolytic solution that contains LiFSI
A second electrolytic solution that does not contain LiFSI (specifically, an electrolytic solution that contains LiPF₆)
A mixed electrolytic solution of the first electrolytic solution and the second electrolytic solution

The maximum value of the current density at 2.80 V to 3.83 V (vs. Li/Li⁺) was measured.

Results are shown in Table 1 below. An example in which the SUS304 foil was used as the working electrode 42 and the mixed electrolytic solution of the first electrolytic solution and the second electrolytic solution was used as the electrolytic solution was used as a reference (=100), and the results are shown with a ratio with respect to the reference.

TABLE 1

| | | Electrolytic solution | | |
|---|---|---|---|---|
| | | Second | | Mixed electrolyte |
| | | electrolytic | First | solution of first |
| | | solution that | electrolytic | electrolytic |
| | | does not contain | solution that | solution and |
| | | LiFSI (contains | contains | second electro- |
| | | LiPF₆) | LiFSI | lytic solution |
| Working | SUS304 | 1.60 | 1295 | 100 |
| electrode | SUS430 | (Not performed) | 1457 | 14767 |

As shown in Table 1, when the first electrolytic solution that contains LiFSI was injected in the first injection step and the first aging step was performed, and then the second electrolytic solution that does not contain LiFSI was injected in addition to the first electrolytic solution in the second injection step and the second aging step was performed, a ratio with respect to a reference value was “1295” in the first aging step and was “100” in the second aging step.

Meanwhile, when the second electrolytic solution that does not contain LiFSI was injected in the first injection step and the first aging step was performed, and then the first electrolytic solution that contains LiFSI was injected in addition to the second electrolytic solution in the second injection step and the second aging step was performed, a ratio with respect to the reference value was “1.60” in the first aging step and was “100” in the second aging step.

In other words, the aging treatment was able to be performed at a ratio of 1295 with respect to the reference value in the first aging step and the aging treatment was able to be performed at a ratio of 100 with respect to the reference value in the second aging step in the former, while the aging treatment was only able to be performed at a ratio of 1.60 with respect to the reference value in the first aging step and then only able to be performed at a ratio of 100 with respect to the reference value in the second aging step in the latter.

From the results above, it was understood that, when SUS304 was mixed into the electrode body, SUS304 was able to be efficiently dissolved and precipitated and the amount of time of the aging treatment as a whole was able to be shortened as a result thereof when the first electrolytic solution that contains LiFSI was injected in the first injection step and the second electrolytic solution that does not contain LiFSI was injected in the second injection step.

Even when SUS430 in addition to SUS304 was mixed into the electrode body, as shown in Table 1, the ratio with respect to the reference value was “1457” in the result in the first electrolytic solution, and the ratio with respect to the reference value was “14767” in the result in the mixed electrolytic solution of the first electrolytic solution and the second electrolytic solution. Therefore, it was understood that, even when SUS430 in addition to SUS304 was mixed, SUS430 was also able to be efficiently dissolved and precipitated when the first electrolytic solution that contains LiFSI was injected in the first injection step and the second electrolytic solution that does not contain LiFSI was injected in the second injection step.

Next, the configuration of the battery manufactured by the method for manufacturing a battery according to the embodiment of the present disclosure is described.

The battery has an electrode body having a positive electrode, a negative electrode, and a separator interposed between the positive electrode and the negative electrode, and a first electrolytic solution and a second electrolytic solution injected into the electrode body.

### Electrolytic Solution

The electrolytic solution is obtained by dissolving or dispersing a supporting salt serving as an electrolyte in a solvent. Examples of the solvent include propylene carbonate (PC), fluoroethylene carbonate (FEC), and ethylene carbonate (EC).

As the supporting salt in the first electrolytic solution (the electrolytic solution that contains lithium bis(fluorosulfonyl)imide), lithium bis(fluorosulfonyl)imide (LiFSI) is preferable.

As the supporting salt in the second electrolytic solution (the electrolytic solution that does not contain lithium bis(fluorosulfonyl)imide), lithium hexafluorophosphate (LiPF₆), for example, is preferable.

The electrolytic solution may include various additive agents (for example, lithium bis(oxalato) borate).

### Negative Electrode

The negative electrode contains at least a negative-electrode active material. The negative electrode may contain at least one of a conductive material and a binder.

Examples of the negative-electrode active material include Li-based active materials such as metallic lithium and lithium alloy; carbon-based active materials such as graphite and hard carbon; oxide-based active materials such as lithium titanate; and Si-based active materials such as simple Si, Si alloy, and silicon oxide. The conductive material and the binder used in the negative electrode are similar to those used in a positive electrode layer described above.

Examples of the negative-electrode active material include metal active materials such as Li and Si, carbon active materials such as graphite, and oxide active materials such as Li₄Ti₅O₁₂. The shape of a negative-electrode current collector is a foil-shape or a mesh-shape, for example.

The conductive material and the binder used in the negative electrode are similar to those used in a positive electrode layer described above. The thickness of the negative electrode is 0.1 μm or more and 1000 μm or less, for example.

### Positive Electrode

The positive electrode has a positive-electrode current collector (for example, an aluminum foil), and a positive-electrode active material layer supported by the positive-electrode current collector, for example. The positive-electrode active material layer contains a well-known positive-electrode active material (for example, LiNiO₂ or LiNi_{1/3}Co_{1/3}Mn_{1/3}O₂(NCM)) and may further contain a well-known conductive material (for example, carbon black) and a well-known binder (for example, polyvinylidene fluoride). The thickness of the positive-electrode active material layer is not particularly limited and is preferably from 0.1 μm to 1 mm.

The working potential of the positive-electrode active material included in the positive electrode is preferably 4 V (vs. Li/Li⁺) or less. When a positive-electrode active material (for example, LFP) of which working potential is 4 V (vs. Li/Li⁺) or less, the effect of dissolving and precipitating the SUS foreign matter by causing the electrolytic solutions to be injected in the first injection step and the second injection step to be in the order described above can be exhibited in a more efficient manner.

### Separator

The separator electrically insulates the positive electrode and the negative electrode and provides a transfer pathway of lithium ions between the positive-electrode active material layer and the negative-electrode active material layer. Examples of the separator include a microporous resin sheet formed by resin such as polyethylene (PE). The separator may be a single layer structure or may be a multilayer structure. The thickness of the separator is not particularly limited and is preferably from 0.1 μm to 1000 μm.

### Use Applications

Examples of use applications of the battery obtained by the method for manufacturing a battery according to the embodiment of the present disclosure include a power source of a hybrid electric vehicle (HEV), a plug-in hybrid electric vehicle (PHEV), a battery electric vehicle (BEV), and the like.

What is claimed is:

1. A method for manufacturing a battery, comprising:
a first injection step of injecting a first electrolytic solution that contains lithium bis(fluorosulfonyl)imide into an electrode body having a positive electrode, a negative electrode, and a separator interposed between the positive electrode and the negative electrode;
a first charging step of performing first charging after the first injection step;
a first aging step of performing aging treatment after the first charging step;
a second injection step of injecting a second electrolytic solution that does not contain lithium bis(fluorosulfonyl)imide into the electrode body after the first aging step;
a second charging step of performing second charging after the second injection step; and
a second aging step of performing aging treatment after the second charging step.

2. The method for manufacturing a battery according to claim 1, wherein the second electrolytic solution contains lithium hexafluorophosphate.

3. The method for manufacturing a battery according to claim 1, wherein a working potential of a positive-electrode active material included in the positive electrode is 4 V (vs. Li/Li⁺) or less.
